(19) United States
(12) Patent Application Publication
(10) Pub. No.: US 2008/0239425 A1
(43) Pub. Date: Oct. 2, 2008

(54) Hologram Recording Apparatus and Method, Hologram Reproducing Apparatus and Method, and Computer Program

(76) Inventor: Kazuyuki Yoshida, Saitama (JP)

Correspondence Address: NIXON & VANDERHYE, PC, 901 NORTH GLEBE ROAD, 11TH FLOOR, ARLINGTON, VA, 22203, US

(21) Appl. No.: 11/887,391

(22) PCT Filed: Mar. 31, 2006
(86) PCT No.: PCT/JP2006/306868

§ 371 Date: Nov. 21, 2007

(30) Foreign Application Priority Data
Mar. 31, 2005 (JP) 2005-102576

(51) Int. Cl. G03H 1/04; G03H 1/22

(52) U.S. Cl. 359/21

(57) ABSTRACT

A hologram recording apparatus is provided with a modulating device for modulating information data in accordance with a modulation rule related to hologram recording/reproduction, to thereby generate a modulation pattern; a judging device for judging whether or not the modulation pattern includes a pattern portion which matches a predetermined target pattern; a changing device for changing at least one portion of the pattern portion to a change pattern if it is judged that the modulation pattern includes the pattern portion which matches the target pattern; and an irradiating device for irradiating beams for recording the modulation pattern, in which at least one portion of the pattern is changed to the change pattern, into a holographic recording medium.

### TECHNICAL FIELD

The present invention relates to a hologram recording apparatus for and a hologram recording method of recording information into a holographic recording medium, a hologram reproducing apparatus for and a hologram reproducing method of reproducing the information from the holographic recording medium, and a computer program used for the hologram recording apparatus and the hologram reproducing apparatus.

### BACKGROUND ART

There is known a hologram recording technique of recording data to be recorded, as an interference pattern, into a holographic recording medium (hereinafter merely referred to as a “recording medium”). In one method, a beam from a source of light is spatially-modulated in accordance with the information to be recorded, by using a modulation pattern obtained by combining two-dimensional white and black patterns, which are generated in accordance with a predetermined modulation rule, to thereby generate object beam, and the recording medium is irradiated with the object beam and reference beam. The object beam and the reference beam form the interference pattern on the recording medium, and the interference pattern is recorded into a recording layer of the recording medium. On the other hand, in reproduction, the interference pattern recorded in the recording medium is irradiated with only the reference beam, and detection beam from the recording medium is detected by a 2-dimensional (2D) sensor, to thereby reproduce the information (refer to a patent document 1)

On the other hand, illegal copying regarding digital data has become one big problem. In the aforementioned hologram recording, more digital data can be recorded into the recording medium, so that the illegal copying can be a bigger problem than ever. In order to address the illegal copying, there has been developed a technology of preventing the illegal copying of data recorded in a recording medium, by intentionally including data different from the data that should be originally provided in advance or to intentionally giving defect to the recording medium, in a range of error correction ability, with respect to the recording medium, such as a CD and a DVD (refer to a patent document 2).

Patent document 1: Japanese Patent Application Laid Open NO. Hei 11-311937
Patent document 2: Japanese Patent Application Laid Open NO. Hei 8-129828

### DISCLOSURE OF INVENTION

### Subject to be Solved by the Invention

In this type of hologram recording technology, there is such a technical problem that the modulation pattern, which is recorded in the holographic recording medium as the interference pattern, cannot be preferably detected in the reproduction, depending on a distribution aspect of each of the white pattern and the black pattern. In order to prevent such a situation, it can be considered to devise the modulation rule used for the modulation. However, since the data recorded in the holographic recording medium can take a random value, even if the modulation rule is devised, the aforementioned situation may not be able to be solved. Moreover, in order to prevent the illegal copying or the like, there is a way to append some auxiliary data, such as copy control information; however, in this regard, it cannot be said that there is no established way suitable for the characteristics of the aforementioned hologram recording.

With regard to the subject to be solved by the present invention, the above can be listed as one example. It is therefore an object of the present invention to provide a hologram recording apparatus and method, which can preferably prevent incorrect detection of the modulation pattern recorded as the interference pattern in the holographic recording medium or which, in addition to the above, can append the auxiliary data efficiently, a hologram reproducing apparatus and method, which are provided with such a template matching processing apparatus, and a computer program which makes a computer as the hologram recording apparatus and the hologram reproducing apparatus.

### Means for Solving the Subject

(Hologram Recording Apparatus)

The above object of the present invention can be achieved by a hologram recording apparatus provided with: a modulating device for modulating information data in accordance with a modulation rule related to hologram recording/reproduction, to thereby generate a modulation pattern; a judging device for judging whether or not the modulation pattern includes a pattern portion which matches a predetermined target pattern; a changing device for changing at least one portion of the pattern portion to a change pattern for change if it is judged by the judging device that the modulation pattern includes the pattern portion which matches the target pattern; and an irradiating device for irradiating beams for recording the modulation pattern, in which at least one portion of the pattern portion is changed to the change pattern, into a holographic recording medium.

According to the hologram recording apparatus of the present invention, by virtue of the operation of the modulating device, the information data including various information, such as video images and sounds, is modulated in accordance with the modulation rule related to the hologram recording/reproduction. As a result, the modulation pattern is generated from the information data. The modulation pattern is used for a object beam out of the beams which is irradiated from the irradiating device. The object beam interferes with the reference beam out of the beams, which is irradiated from the irradiating device, by which an interference pattern is recorded into the holographic recording medium. By this, it is possible to record the information data into the holographic recording medium.

In the present invention, particularly when the modulation pattern is generated, it is judged by the operation of the judging device whether or not the modulation pattern, which is generated by the modulating device, includes the pattern portion which matches the predetermined target pattern. One example of the target pattern is a pattern which has a possibility to cause incorrect detection in reproducing the information data which is recorded as the interference pattern in the holographic recording medium. Alternatively, another example of the target pattern is a pattern which has a possibility to cause some disadvantage in recording the information data into the holographic recording medium or in reproducing the information data which is recorded as the interference pattern in the holographic recording medium. These are defined by the modulation rule related to the hologram recording/reproduction. As a result of the judgment, if it is judged that the modulation pattern, which is generated by the modulating device, includes the pattern portion which matches the predetermined target pattern, at least one portion of the pattern portion is changed to the change pattern by the operation of the changing device. As a result, if the modulation pattern including the target pattern is generated or expected to be generated by the operation of the modulating device, the modulation pattern is generated in such a state that at least one portion of the target pattern is changed to the change pattern. In other words, the modulation pattern is generated on the basis of the information data which is partially different from the information data that is originally intended to be recorded.

By this, it is possible to record the information data as the interference pattern into the holographic recording medium while preferably or appropriately eliminating the target pattern which has a possibility to cause some disadvantage in the recording or in the reproduction, including the incorrect detection in the reproduction. Since the information data is recorded while preferably or appropriately eliminating the target pattern which has a possibility to cause some disadvantage in the recording or in the reproduction, including the incorrect detection in the reproduction, there is a low possibility or little possibility to cause some disadvantage in the recording or in the reproduction. In particular, there is also a lower possibility or little possibility to cause the incorrect detection of the modulation pattern, which is, for example, a combination of a white pattern and a black pattern and which is obtained by reading the interference pattern recorded in the holographic recording medium. Thus, it is possible to preferably prevent the incorrect detection of the modulation pattern recorded as the interference pattern.

Moreover, when the information data is reproduced, as detailed later, it is possible to recognize the original modulation pattern (i.e. the modulation pattern before it is at least partially changed to the change pattern) from the modulation pattern which is at least partially changed to the change pattern by performing an error correction process or the like. As a result, the information data which is originally intended to be recorded can be preferably reproduced. That is, there is no influence on the reproduction of the information data as recorded above. Thus, it is possible to preferably prevent the incorrect detection of the modulation pattern recorded as the interference pattern, and it is also possible to preferably reproduce the information data recorded as the interference pattern in the holographic recording medium.

Incidentally, at least one portion of all the target patterns included in the modulation pattern is not necessarily changed to the change pattern. That is, if at least one portion of at least one target pattern is changed to the change pattern, it is possible to appropriately prevent the disadvantage in the recording or in the reproduction, including the incorrect detection in the reproduction. Of course, in order to more preferably prevent the disadvantage in the recording or in the reproduction, at least one portion of more target patterns included in the modulation pattern as possible is preferably changed to the change pattern.

In one aspect of the hologram recording apparatus of the present invention, the change pattern is generated by modulating auxiliary data for controlling at least one of recording and reproduction of the information data, in accordance with the modulation rule.

According to this aspect, the modulation pattern, which is generated by modulating the auxiliary data for controlling at least one of the recording and the reproduction of the information data (i.e. for controlling the operation of the hologram recording apparatus, the operations of a hologram reproducing apparatus and a computer program described later, or the like), can be used as the change pattern.

Incidentally, the auxiliary data may be essential data to operate the hologram recording apparatus, the hologram reproducing apparatus described later, and the computer program described later. That is, the hologram recording apparatus, the hologram reproducing apparatus described later, and the computer program described later may be constructed so as not to performing a recording operation and a reproduction operation without reference to the auxiliary data, or the like. However, the hologram recording apparatus, the hologram reproducing apparatus described later, and the computer program described later may be also constructed so as to perform the recording operation and the reproduction operation without reference to the auxiliary data, or the like. More specifically, the auxiliary data may be copy control information for controlling the recording or reproduction of the record data or the like. In this case, it may be preferably constructed so as to perform the recording operation and the reproduction operation only if the correct copy control information is obtained.

In an aspect of the hologram recording apparatus in which the change pattern is generated by modulating the auxiliary data, as described above, the modulation rule for the auxiliary data may be different from the modulation rule for the information data.

By virtue of such construction, an auxiliary pattern which is used as the change pattern is different from the modulation pattern which is generated by modulating the information data. Therefore, such possibility is reduced that the modulation pattern includes the pattern portion which matches the target pattern after the changing to the change pattern. Therefore, it is possible to perform the change operation using the auxiliary pattern (i.e. the change pattern), more efficiently.

In another aspect of the hologram recording apparatus of the present invention, the modulating device modulates the information data while appending an error correction code to the information data.

According to this aspect, the error correction process is performed on the information data obtained from the modulation pattern which is partially changed to the change pattern, to thereby preferably obtain the original information data (i.e. the information data which is originally intended to be recorded in the recording) from the original modulation pattern. Therefore, it is possible to preferably reproduce the information data which is recorded as the interference pattern in the holographic recording medium.

In an aspect of the hologram recording apparatus in which the modulation is performed while the error correction code is appended to the information data, as described above, the changing device may change the at least one portion of the pattern portion to the change pattern while satisfying an error correction ability of the error correction code which is appended to the information data.

By virtue of such construction, it is possible to preferably and certainly obtain the original data (i.e. the information data which is originally intended to be recorded in the recording) from the original modulation pattern by performing the error correction process.

In an aspect of the hologram recording apparatus in which the change pattern is generated by modulating the auxiliary data, the modulating device may modulate the information data while appending an error correction code to the auxiliary data.

By virtue of such construction, it is possible to preferably perform the error correction process on the auxiliary data which is recorded with it appended to the information data.

In an aspect of the hologram recording apparatus in which the modulation is performed while the error correction code is appended to the information data, as described above, the changing device may be provided with a number-of-times controlling device for controlling the number of times of the changing to the change pattern in the modulation pattern.

By virtue of such construction, the changing to the change pattern can be performed while the error correction ability of the error correction code, which is appended to the information data, is satisfied.

In an aspect of the hologram recording apparatus in which the modulation is performed while the error correction code is appended to the information data, as described above, the changing device may be provided with a position controlling device for controlling a position in which the changing to the change pattern is performed in the modulation pattern.

By virtue of such construction, the changing to the change pattern can be performed while the error correction ability of the error correction code, which is appended to the information data, is satisfied.

In an aspect of the hologram recording apparatus in which the modulation is performed while the error correction code is appended to the information data, as described above, the changing device may be provided with a position selecting device for preferentially selecting a position in which the changing to the change pattern is performed in the modulation pattern.

By virtue of such construction, the changing to the change pattern can be performed while the error correction ability of the error correction code, which is appended to the information data, is satisfied.

In another aspect of the hologram recording apparatus of the present invention, the judging device judges on the basis of judgment information which defines whether or not the modulation pattern, which is arbitrary and which is generated in accordance with the modulation rule, is changed to the change pattern.

According to this aspect, a judgment operation by the judging device can be performed, preferably and efficiently.

In another aspect of the hologram recording apparatus of the present invention, the modulating device generates the modulation pattern by combining unit patterns, each of which is generated by modulating one unit of the information data, in a matrix of N×M (wherein each of N and M is an integer of 1 or more), and the changing device changes the unit pattern, as at least one portion of the pattern portion, to the change pattern.

According to this aspect, the modulation pattern in the matrix can be preferably generated from the information data, and the changing to the change pattern can be performed by a unit of the unit pattern.

In an aspect of the hologram recording apparatus in which the modulation pattern is generated by combining the unit patterns in the matrix of N×M, as described above, the judging device may judge whether or not the modulation pattern includes the pattern portion which matches the target pattern having a size of a matrix of n×m (wherein n<N and m<M).

By virtue of such construction, it is possible to preferably judge whether the modulation pattern includes the target pattern which is smaller than the modulation pattern, and to perform the changing to the change pattern by a unit of the unit pattern.

(Hologram Recording Method)

The above object of the present invention can be also achieved by a hologram recording method provided with: a modulating process of modulating information data in accordance with a modulation rule related to hologram recording/reproduction, to thereby generate a modulation pattern; a judging process of judging whether or not the modulation pattern includes a pattern portion which matches a predetermined target pattern; a changing process of changing at least one portion of the pattern portion to a change pattern for change if it is judged by the judging device that the modulation pattern includes the pattern portion which matches the target pattern; and an irradiating process of irradiating beams for recording the modulation pattern, in which at least one portion of the pattern portion is changed to the change pattern, into a holographic recording medium.

According to the hologram recording method of the present invention, it is possible to receive the same various benefits as those of the hologram recording apparatus of the present invention described above.

Incidentally, in response to various aspects as those of the hologram recording apparatus of the present invention, the hologram recording method of the present invention can also employ various aspects.

(Hologram Reproducing Apparatus)

The above object of the present invention can be also achieved by a hologram reproducing apparatus for reproducing information data which is recorded on a holographic recording medium by a hologram recording apparatus provided with: a modulating device for modulating the information data in accordance with a modulation rule related to hologram recording/reproduction, to thereby generate a modulation pattern; a judging device for judging whether or not the modulation pattern includes a pattern portion which matches a predetermined target pattern; a changing device for changing at least one portion of the pattern portion to a change pattern, which is generated by modulating auxiliary data for controlling at least one of recording and reproduction of the information data, in accordance with the modulation rule, if it is judged by the judging device that the modulation pattern includes the pattern portion which matches the target pattern; and an irradiating device for irradiating beams for recording the modulation pattern, in which at least one portion of the pattern portion is changed to the change pattern, into the holographic recording medium, the hologram reproducing apparatus provided with: a reading device for reading the modulation pattern recorded on the holographic recording medium; a demodulating device for demodulating the read modulation pattern in accordance with the modulation rule to thereby generate demodulation data; an obtaining device for performing an error correction process on the demodulation data to thereby obtain the information data; and an extracting device for extracting a data portion of the demodulation data which is different from the information data, as the auxiliary data.

According to the hologram reproducing apparatus of the present invention, by virtue of the operation of the reading device, the modulation pattern, which is at least partially changed to the change pattern, is read. The read modulation pattern is demodulated by the operation of the demodulating device. As a result, the demodulation data is generated. Then, by virtue of the operation of the obtaining device, the error correction process is performed on the demodulation data. By this, the information data, which is obtained by demodulating the modulation pattern before the change to the change pattern (i.e. the information data which is originally intended to be recorded in the recording), is obtained.

On the other hand, by virtue of the operation of the extracting device, a difference between the demodulation data on which the error correction process is not performed and the information data after the error correction process is performed is compared. At this time, the auxiliary data which is embedded in the information data due to the change by using the change pattern is corrected to the original information data by the error correction process. Therefore, it is found out that the data portion at which there is difference between before-error-correction-state and after-error-correction-state is the auxiliary data. Therefore, by virtue of the operation of the extracting device, the data portion of the demodulation data, at which there is difference from the information data, is extracted as the auxiliary data.

By this, it is possible to preferably reproduce the information data which is recorded in the holographic recording medium by using the modulation pattern which is at least partially changed to the change pattern. It is also possible to preferably reproduce the auxiliary data. Moreover, since the changing by the change pattern is performed, it is possible to preferably prevent the incorrect detection of the modulation pattern recorded as the interference pattern.

Incidentally, in response to various aspects of the hologram recording apparatus of the present invention described above, the hologram reproducing apparatus of the present invention can also employ various aspects.

(Hologram Reproducing Method)

The above object of the present invention can be also achieved by a hologram reproducing method of reproducing information data which is recorded on a holographic recording medium by a hologram recording apparatus provided with: a modulating device for modulating the information data in accordance with a modulation rule related to hologram recording/reproduction, to thereby generate a modulation pattern; a judging device for judging whether or not the modulation pattern includes a pattern portion which matches a predetermined target pattern; a changing device for changing at least one portion of the pattern portion to a change pattern, which is generated by modulating auxiliary data for controlling at least one of recording and reproduction of the information data, in accordance with the modulation rule, if it is judged by the judging device that the modulation pattern includes the pattern portion which matches the target pattern; and an irradiating device for irradiating beams for recording the modulation pattern, in which at least one portion of the pattern portion is changed to the change pattern, into the holographic recording medium, the hologram reproducing method provided with: a reading process of reading the modulation pattern recorded on the holographic recording medium; a demodulating process of demodulating the read modulation pattern in accordance with the modulation rule to thereby generate demodulation data; an obtaining process of performing an error correction process on the demodulation data to thereby obtain the information data; and an extracting process of extracting a data portion of the demodulation data which is different from the information data, as the auxiliary data.

According to the hologram reproducing method of the present invention, it is possible to receive the same various benefits as those of the hologram reproducing apparatus of the present invention described above.

Incidentally, in response to various aspects as those of the hologram reproducing apparatus of the present invention, the hologram reproducing method of the present invention can also employ various aspects.

(Computer Program)

The above object of the present invention can be also achieved by a first computer program for hologram recording control to control a computer provided in the aforementioned hologram recording apparatus of the present invention (including its various aspects), the computer program making the computer function as at least one portion of the modulating device, the judging device, the changing device, and the irradiating device. The above object of the present invention can be also achieved by a second computer program for hologram reproduction control to control a computer provided in the aforementioned hologram reproducing apparatus of the present invention (including its various aspects), the computer program making the computer function as at least one portion of the reading device, the demodulating device, the obtaining device, and the extracting device.

According to each of the computer programs of the present invention, the aforementioned hologram recording apparatus or hologram reproducing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the aforementioned hologram recording apparatus or hologram reproducing apparatus of the present invention, each of the computer programs of the present invention can also adopt various aspects.

The above object of the present invention can be also achieved by a first computer program product in a computer-readable medium for tangibly embodying a program of instructions executable by a computer provided in the aforementioned hologram recording apparatus of the present invention (including its various aspects), the computer program product making the computer function as at least one portion of the modulating device, the judging device, the changing device, and the irradiating device. The above object of the present invention can be also achieved by a second computer program product in a computer-readable medium for tangibly embodying a program of instructions executable by a computer provided in the aforementioned hologram reproducing apparatus of the present invention (including its various aspects), the computer program product making the computer function as at least one portion of the reading device, the demodulating device, the obtaining device, and the extracting device.

According to each of the computer program products of the present invention, the aforementioned hologram recording apparatus or hologram reproducing apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, into the computer via a communication device. More specifically, the computer program product may include computer readable codes to cause the computer (or may comprise computer readable instructions for causing the computer) to function as the aforementioned hologram recording apparatus or hologram reproducing apparatus of the present invention.

These effects and other advantages of the present invention will become more apparent from the embodiment explained below.

As explained above, according to the aforementioned hologram recording apparatus of the present invention, it is provided with the modulating device, the judging device, the changing device, and the irradiating device. According to the aforementioned hologram recording method of the present invention, it is provided with the modulating process, the judging process, the changing process, and the irradiating process Moreover, according to the aforementioned hologram reproducing apparatus of the present invention, it is provided with the reading device, the demodulating device, the obtaining device, and the extracting device. According to the aforementioned hologram reproducing method of the present invention, it is provided with the reading process, the demodulating process, the obtaining process, and the extracting process. Therefore, it is possible to preferably prevent the incorrect detection of the modulation pattern recorded as the interference pattern.

### BRIEF DESCRIPTION OF DRAWINGS

FIG. 1 is a block diagram conceptually showing the structure of an optical system of a hologram recording/reproducing apparatus in an embodiment.

FIG. 2 is a block diagram conceptually showing the structure of a signal processing system of the hologram recording/reproducing apparatus in the embodiment.

FIG. 3 is a schematic diagram showing one example of a two-dimensional (2D) digital modulation method.

FIG. 4 is a schematic diagram conceptually showing an example in which actual user data or the like is 2D-digital-modulated by the two-dimensional digital modulation method shown in FIG. 3.

FIG. 5 is a schematic diagram pointing out the problem of 2D-modulation image patterns shown in FIG. 4.

FIG. 6 is a flowchart conceptually showing a flow of a recording operation (in particular, an operation related to a pattern change) of the hologram recording/reproducing apparatus in the embodiment.

FIG. 7 are schematic diagrams showing a search area which is set.

FIG. 8 is a table roughly showing the specific structure of a judgment table.

FIG. 9 is a schematic diagram conceptually showing an aspect of an operation of judging whether or not the pattern is to be changed, with respect to the 2D modulation image pattern which is obtained by 2D-digital-modulating the actual user data or the like.

FIG. 10 is a schematic diagram conceptually showing an aspect of the pattern change operation, with respect to the 2D modulation image pattern which is obtained by 2D-digital-modulating the actual user data or the like.

FIG. 11 is a block diagram conceptually showing the specific structure of a modulation pattern change circuit.

FIG. 12 is a schematic diagram conceptually showing a data flow in a reproduction operation of a hologram reproducing apparatus in an embodiment.

FIG. 13 is a schematic diagram conceptually showing an aspect of modulating the user data and auxiliary data on a hologram recording/reproducing apparatus in a modified example.

### DESCRIPTION OF REFERENCE CODES

1 holographic recording medium
10 pickup
11 recording/reproduction laser
12, 16 beam splitter
13, 15 mirror
14 spatial modulator
17 half mirror
18 two-dimensional sensor
19 objective lens
100 recording system circuit
111, 112 error correction code generation/appending circuit
121, 122 two-dimensional modulation circuit
131 modulation pattern change circuit
132 pattern change circuit
133 pattern change judgment circuit
141 writing circuit
200 reproduction system circuit
211 reading circuit
221 pattern detection circuit
231 two-dimensional demodulation circuit
241, 243 error correction circuit
242 auxiliary data extraction circuit

### BEST MODE FOR CARRYING OUT THE INVENTION

Hereinafter, the best mode for carrying out the present invention will be explained in order in each embodiment with reference to the drawings.

### (1) Basic Structure

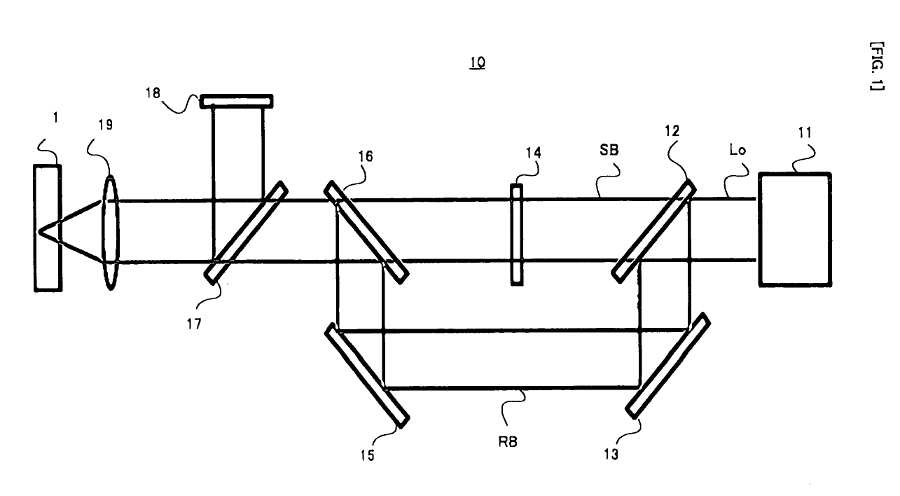

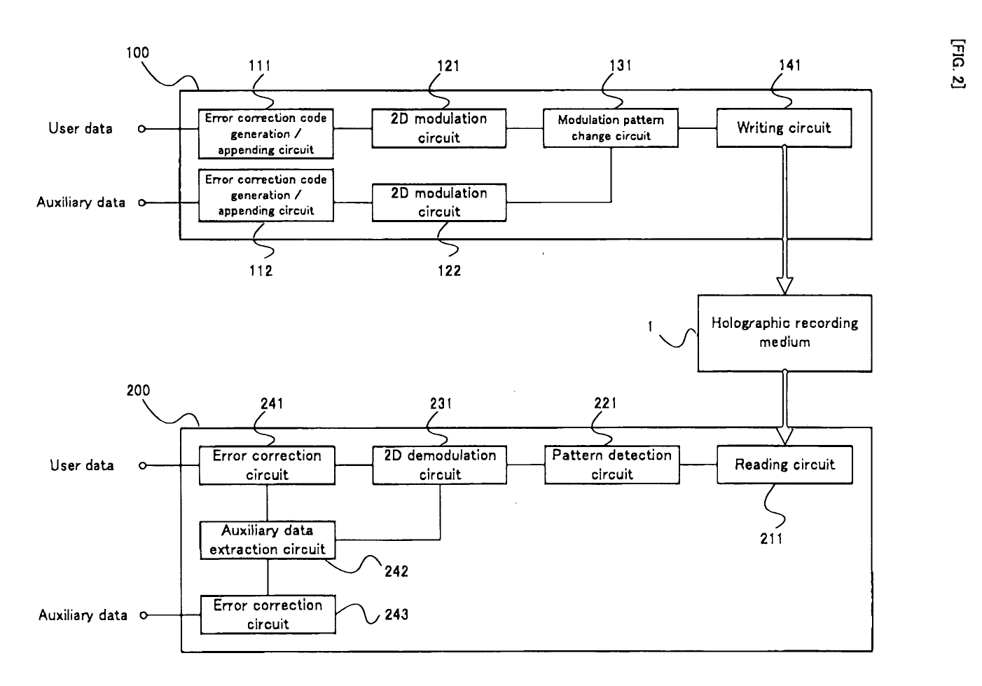

Firstly, with reference to FIG. 1 and FIG. 2, the basic structure of a hologram recording/reproducing apparatus in this embodiment will be explained. FIG. 1 is a block diagram conceptually showing, particularly, the structure of an optical system, which is disposed in a pickup, of the hologram recording/reproducing apparatus in the embodiment. FIG. 2 is a block diagram conceptually showing, particularly, the structure of a signal processing system of the hologram recording/reproducing apparatus in the embodiment.

As shown in FIG. 1, a pickup 10 is provided with: a recording/reproduction laser 11 which generates laser beam for recording or reproducing user data or the like.

In the recording of the information data, a light beam Lo emitted from the recording/reproduction laser 11 is divided by a beam splitter 12 into a signal beam SB as signal light and a reference beam RB as reference light for recording. The signal beam SB is inputted to a spatial modulator 14. The spatial modulator 14 can be formed of e.g. a liquid crystal element and has a plurality of pixels arranged in a lattice pattern.

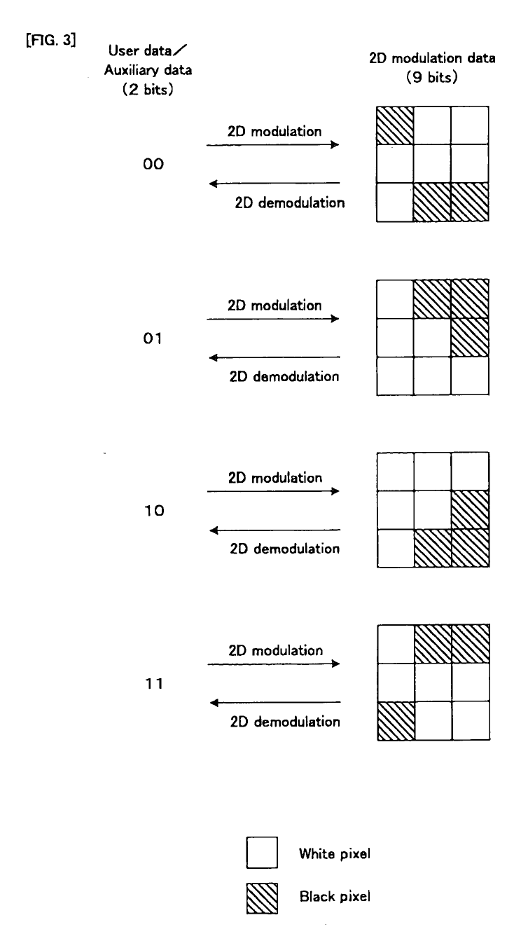

The spatial modulator 14 displays a two-dimensional (2D) modulation image pattern, which includes white pixels and black pixels and which is obtained by 2D digital-modulating the user data to be recorded. And the spatial modulator 14 spatially-modulates the signal beam SB by using the 2D modulation image patterns. Incidentally, a specific aspect of the 2D-digital modulation will be detailed later (refer to FIG. 3).

The signal beam SB, which is spatially-modulated by the spatial modulator 14, and the reference beam RB, whose optical path is adjusted by mirrors 13 and 15, are merged on the same optical axis by a beam splitter 16, and then transmitted through a half mirror 17, focused by an objective lens 19, and irradiated onto a holographic recording medium 1. As a result, the spatial-modulated signal beam SB and the reference beam RB form an interference pattern in the holographic recording medium 1, and the interference pattern is recorded into the holographic recording medium 1.

On the other hand, in the information reproduction, the spatial modulator 14 is controlled in a non-modulation condition (i.e. all-optical transmission condition). Thus, the light beam Lo emitted from the recording/reproduction laser 11 passes through the half mirror 17 and the objective lens 19, without being modulated by the spatial modulator 14, and is irradiated onto the recording medium 1. The light beam becomes reference beam for reproduction. In the holographic recording medium 1, detection beam (SB) is generated from the reference beam for reproduction and the interference pattern recorded in the recording medium 1, and the SB passes through the objective lens 19, and is reflected by the half mirror 17, and enters a 2D sensor 18. The 2D sensor 18 can be, for example, a CCD array, a CMOS sensor, or the like, and it outputs an electrical signal according to the amount of incident light. In this manner, the 2D modulation image patterns including the white and black pixels, displayed by the spatial modulator 14 in the recording, are formed on the 2D sensor 18, and the recorded user data or the like is obtained by detecting this pattern.

Next, with reference to FIG. 2, an explanation will be given on the structure of the signal processing system of the hologram recording/reproducing apparatus in the embodiment.

As shown in FIG. 2, the hologram recording/reproducing apparatus in the embodiment is provided with: a recording system circuit 100; and a reproduction system circuit 200. The recording system circuit 100 is provided with: error correction code generation/appending circuits 111 and 112; two-dimensional (2D) modulation circuits 121 and 122; a modulation pattern change circuit 131; and a writing circuit 141. The reproduction system circuit 200 is provided with: a reading circuit 211; a pattern detection circuit 221; a 2D demodulation circuit 231; error correction circuits 241 and 243; and an auxiliary data extraction circuit 242.

Each of the error correction code generation/appending circuits 111 and 112 generates and appends an error correction code for error correction, with respect to user data and auxiliary data. As the error correction code, for example, a parity check code, an ECC (Error Correction Code), and the like are listed as one specific example. In particular, the error correction code generation/appending circuit 111 generates an error correction code for the user data and appends the generated error correction code to the user data. Moreover, the error correction code generation/appending circuit 112 generates an error correction code for the auxiliary data and appends the generated error correction code to the auxiliary data.

Incidentally, the user data includes e.g. video data, audio data, PC data, or the like. Moreover, the auxiliary data is data for controlling the recording and reproduction of the user data. It is, for example, data for protecting copyright or the like of the user data, or management data and control data for managing and controlling a recording operation and a reproduction operation.

The 2D modulation circuits 121 and 122 perform 2D digital modulation with respect to the user data and the auxiliary data, and generate the 2D modulation image patterns. That is, the aforementioned spatial modulator 14 operates to display the 2D modulation image pattern each of which is generated by the 2D modulation circuits 121 and 122. In particular, the 2D modulation circuit 121 performs the 2D digital modulation with respect to the user data, to thereby generate the 2D modulation image patterns of the user data. The 2D modulation circuit 122 performs the 2D digital modulation with respect to the auxiliary data, to thereby generate the 2D modulation image patterns of the auxiliary data.

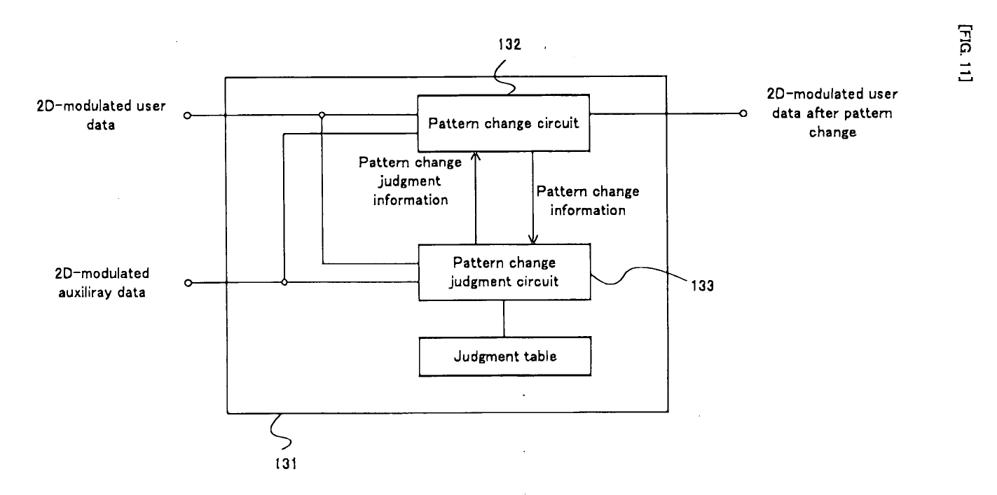

The modulation pattern change circuit 131 changes one portion of the 2D modulation image pattern of the user data which is generated by the 2D modulation circuit 121, with using the 2D modulation image pattern of the auxiliary data which is generated by the 2D modulation circuit 122. The structure and the operation of the modulation pattern change circuit 131 will be detailed later (refer to FIG. 11 or the like).

The writing circuit 141 actually records the 2D modulation image pattern into the holographic recording medium 1. That is, on the basis of an instruction from the writing circuit 141, the light beam Lo is emitted from the recording/reproduction laser 11, and the 2D modulation image pattern is displayed on the spatial modulator 14. As a result, the user data and the auxiliary data are recorded in the holographic recording medium 1 as the interference pattern.

The reading circuit 211 reads the user data and the auxiliary data which are recorded in the holographic recording medium 1 as the interference pattern. More specifically, on the basis of an instruction of the reading circuit 211, the light beam Lo is emitted from the recording/reproduction laser 11 and the spatial modulator 14 becomes in the non-modulation condition. As a result, the detection light, which is generated by the reference light for reproduction and interference pattern recorded in the holographic recording medium 1, enter the 2D sensor 18.

The pattern detection circuit 221 analyzes the detection light which enters the 2D sensor 18, to thereby detect the 2D modulation image pattern (in particular, the positions of white pixel portion and black pixel portion in the 2D modulation image pattern) displayed on the spatial modulator 14 in the recording

The 2D demodulation circuit 231 two-dimensionally demodulates the 2D modulation image pattern, which is detected by the pattern detection circuit 221, to thereby generate demodulation data.

The error correction circuit 241 performs an error correction process with respect to the demodulation data, to thereby generate the recorded information data. As a result, the recorded information data can be reproduced.

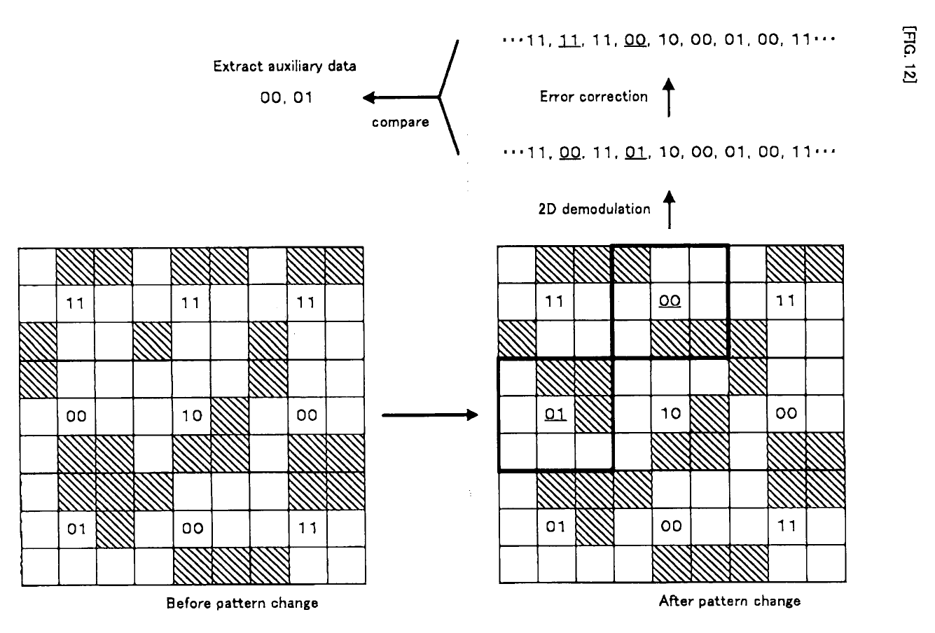

The auxiliary data extraction circuit 242 compares the demodulation data, which is generated by the 2D demodulation circuit 231, with the information data, which is generated by the error correction circuit 241, to thereby extract the auxiliary data included in the demodulation data. The extraction process of extracting the auxiliary data will be detailed later (refer to FIG. 12).

The error correction circuit 243 performs an error correction process with respect to the auxiliary data, which is extracted by the auxiliary data extraction circuit 242, to thereby generate the auxiliary data without error. As a result, the recorded auxiliary data can be reproduced.

### (2) Modulation Aspect

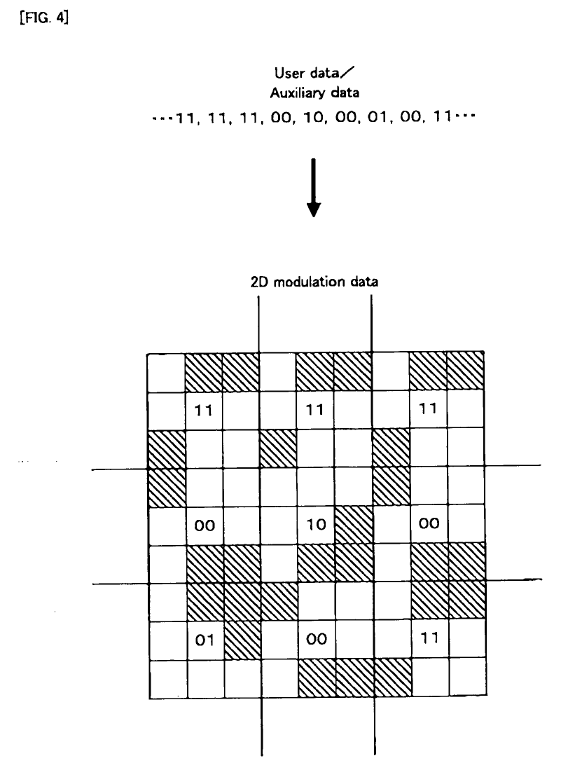

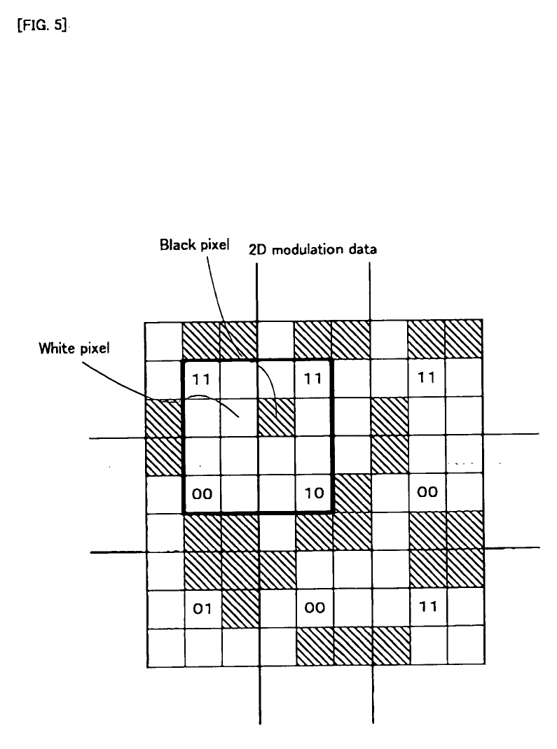

Next, with reference to FIG. 3 to FIG. 5, a specific aspect of the 2D digital modulation will be explained. FIG. 3 is a schematic diagram showing one example of a 2D digital modulation method. FIG. 4 is a schematic diagram conceptually showing an example in which the actual user data or the like is 2D-digital-modulated by the two-dimensional digital modulation method shown in FIG. 3. FIG. 5 is a schematic diagram pointing out the problem of 2D-modulation image patterns shown in FIG. 4.

As shown in FIG. 3, each of 2-bit combinations “00”, “01”, “10”, and “11” of the digital user data or the like, i.e. the user data or the like to be recorded into the holographic recording medium 1, is expressed by a combination of the white pixels and the black pixels which are arranged in a matrix of 3×3. In this example, the 2-bit user data or the like is converted to the 2D-modulation data having nine pixels (i.e. the 2D modulation image pattern).

FIG. 4 shows the 2D modulation data obtained by 2D-digital-modulating the user data or the like, which is expressed by e.g. “ . . . 111111001000010011 . . . (i.e. if it is divided by two bits, 11, 11, 11, 00, 10, 00, 01. 00, 11 . . . ), by this modulation method. This will be explained more specifically. After the data row of the user data or the like is divided by two bits, the divided two bits are 2D-digital-modulated to the 2D modulation image pattern having nine pixels. After that, depending on the order (or position) in the original data row of the divided two bits, the 2D modulation image pattern having nine pixels is arranged in order, for example, from the upper left to the lower right. By this, the 2D modulation image pattern corresponding to the user data or the like is generated. The 2D modulation image pattern, which consists of the white pixels and the black pixels, is displayed on the spatial modulator 14. The signal beam SB, which enters the spatial modulator 14, is transmitted through in the white pixel portion of the 2D modulation image pattern and is blocked in the black pixel portion. Thus, the signal beam SB, which is optically spatial-modulated by the 2D modulation image pattern, is emitted from the spatial modulator 14. Incidentally, the aforementioned example is one example of the 2D digital modulation, and the application of the present invention is not limited to the aforementioned modulation method. As long as the inputted user data or the like can be converted to the 2D modulation image pattern and a flux of light can be spatial-modulated by driving the spatial modulator 14, any 2D digital modulation method may be used, such as a so-called 2:4 difference modulation method in which two-bit user data is converted to four-bit 2D modulation data.

Now, considering the 2D modulation image pattern shown in FIG. 4 more specifically, it is found out that the 2D modulation image pattern has a problem described below. Specifically, as shown in FIG. 5, it is clear that a portion which is surrounded by a thick frame out of the 2D modulation image pattern has one black pixel surrounded by a plurality of white pixels. When such a 2D modulation pattern is detected by the pattern detection circuit 221, there is a possibility that one black pixel is incorrectly detected to be one white pixel because of the plurality of white pixels surrounding one black pixel. Thus, if nothing is done, it is possibly reproduced as the user data that is different from the originally recorded user data or the like. This may lead to the deterioration of the reproduction quality. This is not preferable from the viewpoint of preferable recording and reproduction of the user data or the like.

Thus, when recording such 2D modulation image pattern, the hologram recording/reproducing apparatus in the embodiment performs a process for preferably preventing the incorrect detection in reading (specifically, a process of changing the auxiliary data and the 2D modulation image patterns, which will be detailed later), before the recording process. Hereinafter, such a process will be explained more specifically.

### (3) Recording Operation

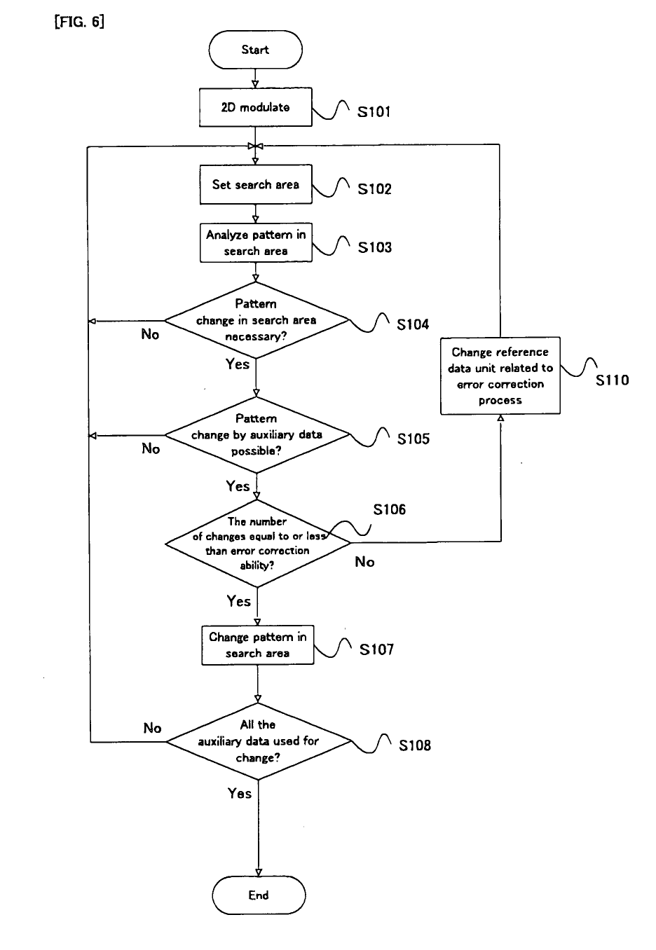

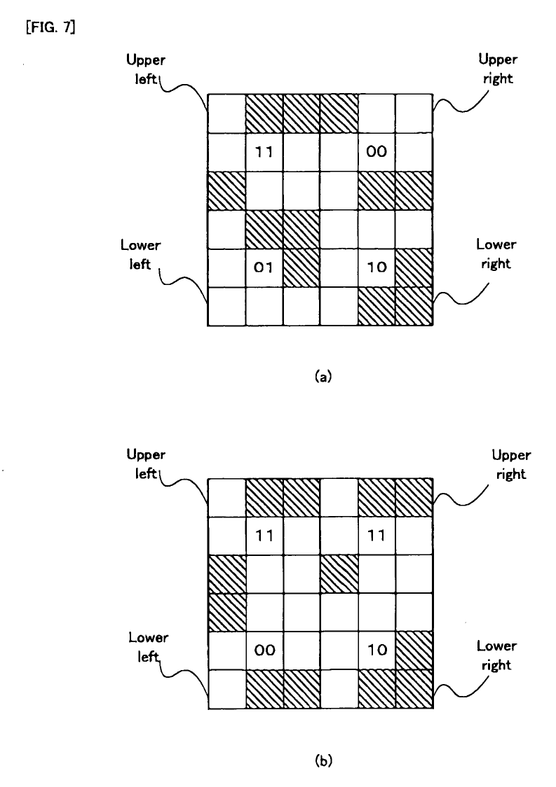

Next, with reference to FIG. 6 to FIG. 11, an explanation will be given on the recording operation (in particular, the operation related to the pattern change) of the hologram recording/reproducing apparatus in the embodiment. Here, while an entire flow of the recording operation (in particular, the operation related to the pattern change) is explained by using FIG. 6, a more detailed explanation will be given with reference to FIG. 7 to FIG. 11, as occasion demands. FIG. 6 is a flowchart conceptually showing a flow of the recording operation (in particular, the operation related to the pattern change) of the hologram recording apparatus in the embodiment. Incidentally, in the embodiment, except for the operation related to the pattern change, the user data or the like is recorded into the holographic recording medium 1 in the same aspect as that of a conventional hologram recording/reproducing apparatus.

As shown in FIG. 6, firstly, by virtue of the operation of the 2D modulation circuits 121 and 122, the user data and the auxiliary data to be recorded in the holographic recording medium 1 are 2D-modulated (step S101). As a result, the 2D modulation image patterns shown in FIG. 4 are generated.

Then, by virtue of the operation of the modulation pattern change circuit 131, a search area in the 2D modulation image patterns generated in the step S101, at which it is searched for whether or not an image pattern which is to be changed to the 2D pattern of the auxiliary data is included, is set (step S102).

The search area will be explained in more details with reference to FIG. 7. FIG. 7 are schematic diagrams showing the search area which is set.

As shown in FIG. 7(a) and FIG. 7(b), the search area is set as an area in which combination of two matrix of 3×3 (i.e. the 2D modulation image patterns generated by 2D-digital-modulating the 2-bit user data or the like) which includes the white pixels and the black pixels are arranged in a longitudinal direction (or X direction) and combination of two matrix are arranged in a lateral direction (or Y direction). That is, four of the 2D modulation image patterns, each of which is generated by 2D-digital-modulating the 2-bit user data or the like, are extracted in an aspect of matrix of 2×2 from the 2D modulation image pattern having a size of a matrix of N×M, which are generated in the step S101 in FIG. 6, to thereby set the search area. In other words, the 2D modulation image patterns, each of which is generated by 2D-digital-modulating the 2-bit user data or the like, is arranged in each of the upper left, upper right, lower left, and lower right of the search area. Incidentally, the 2-bit user data or the like constitutes one specific example of the “information data” of the present invention.

In FIG. 6 again, by virtue of the operation of the modulation pattern change circuit 131, the 2D modulation image patterns in the search area are analyzed (step S103). Specifically, the arrangement of the white pixels and the black pixels in the 2D modulation image pattern in the search area, or the values of the user data or the like, which constitute the 2D modulation image pattern, are analyzed.

After that, by virtue of the operation of the modulation pattern change circuit 131, it is judged whether or not it is necessary to change the pattern in the search area (step S104). In other words, it is judged whether or not there is a portion in the search area at which one black pixel is surrounded by a plurality of white pixels. If there is a portion in the search area at which one black pixel is surrounded by a plurality of white pixels, it is judged that it is necessary to change the pattern in the search area. On the other hand, if there is no portion in the search area at which one black pixel is surrounded by a plurality of white pixels, it is judged that it is not necessary to change the pattern in the search area. This judgment is performed specifically on the basis of a judgment table which defines a relationship between an aspect of arranging the user data or the like in the search area and necessity for changing the 2D modulation image pattern in the aspect.

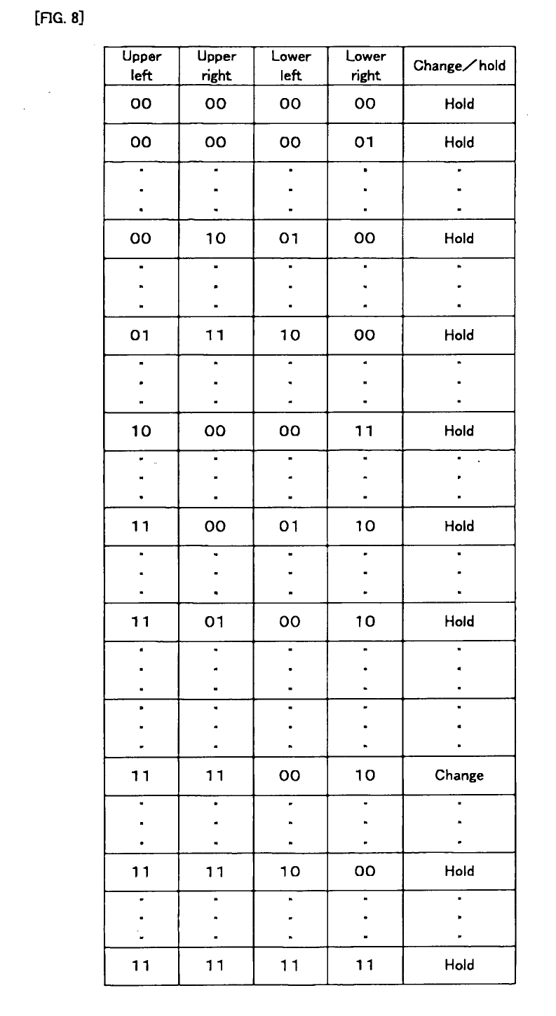

Now, with reference to FIG. 8, the specific structure of the judgment table is explained. FIG. 8 is a table roughly showing the specific structure of the judgment table.

As shown in FIG. 8, the judgment table includes: values indicated by the 2D modulation image patterns, which are arranged in the upper left, upper right, lower left, and lower right of the search area, respectively; and information which indicates whether the pattern in the search area is to be changed or not (i.e. to be held or not). It can be said that the judgment table includes: the values indicated by the 2D modulation image patterns, which are arranged in the upper left, upper right, lower left, and lower right of the search area, respectively; and information which indicates whether or not there is a portion in the search area at which one black pixel is surrounded by a plurality of white pixels. That is, if there is a portion in the search area at which one black pixel is surrounded by a plurality of white pixels, there is associated such information that indicates that the pattern in the search area is to be changed. On the other hand, if there is no portion in the search area which one black pixel is surrounded by a plurality of white pixels, there is associated such information that indicates that the patterns in the search area are to be held.

For example, the judgment table shown in FIG. 8 defines that the patterns in the search area are to be held (i.e. not to be changed), if the 2D modulation image pattern obtained by 2D-digital-modulating the user data or the like “11” is arranged in the upper left of the search area, the 2D modulation image pattern obtained by 2D-digital-modulating the user data or the like “00” is arranged in the upper right of the search area, the 2D modulation image pattern obtained by 2D-digital-modulating the user data or the like “01” is arranged in the lower left of the search area, and the 2D modulation image pattern obtained by 2D-digital-modulating the user data or the like “10” is arranged in the lower right of the search area (i.e. if the search area is set in the aspect shown in FIG. 7(a)). On the other hand, the judgment table defines that the pattern in the search area is to be changed, if the 2D modulation image pattern obtained by 2D-digital-modulating the user data or the like “11” is arranged in the upper left of the search area, the 2D modulation image pattern obtained by 2D-digital-modulating the user data or the like “11” is arranged in the upper right of the search area, the 2D modulation image pattern obtained by 2D-digital-modulating the user data or the like “00” is arranged in the lower left of the search area, and the 2D modulation image pattern obtained by 2D-digital-modulating the user data or the like “10” is arranged in the lower right of the search area (i.e. if the search area is set in the aspect shown in FIG. 7(b)). The modulation pattern change circuit 131 judges whether or not the pattern is to be changed while referring to the aspect of arranging the user data or the like in the search area, which is set in the step S102 in FIG. 6, on the basis of the judgment table.

In FIG. 6 again, as a result of the judgment in the step S104, if it is judged that it is not necessary to change the pattern in the search area (the step S104: No), the operational flow returns to the step S102, and a new search area is set, and the operations in the steps S103 and S104 are repeated.

On the other hand, as a result of the judgment in the step S104, if it is judged that it is necessary to change the pattern in the search area (the step S104: Yes), then it is judged whether or not the pattern in the search area (specifically, one portion of the patterns in the search area) can be changed to the 2D modulation pattern, which is generated by 2D-digital-modulating the auxiliary data (step S105). Specifically, it is judged that the pattern can be changed, if the portion at which one black pixel is surrounded by a plurality of white pixels is eliminated from the search area by changing the pattern in the search area to the 2D modulation pattern, which is generated by 2D-digital-modulating the auxiliary data. On the other hand, even if the pattern in the search area is changed to the 2D modulation pattern, which is generated by 2D-digital-modulating the auxiliary data, if there is still the portion in the search area at which one black pixel is surrounded by a plurality of white pixels, it is judged that the pattern cannot be changed. Even in this case, it is preferable to refer to the judgment table used in FIG. 8.

As a result of the judgment in the step S105, if it is judged that the pattern cannot be changed (the step S105: No), the patterns in the search area are not changed. After that, the operation flow returns to the step S102, a new search area is set, and the operations in the steps S103 and S104 are repeated.

On the other hand, if it is judged that the pattern can be changed (the step S105: Yes), then, it is judged whether or not the number of changes is in a range of the error correction ability of the error correction code which is appended to the user data by the operation of the error correction code generation/appending circuit 111 (step S106). That is, it is judged whether or not the number of changes is to the extent that the user data or the like before the pattern change can be obtained by performing the error correction process, even if the pattern is changed. In other words, the upper limit of the number of changing the patterns is determined in a reference block unit related to the error correction process, and it is judged whether or not the pattern is changed beyond the upper limit.

Moreover, in order to make the number of the changes in the range of the error correction ability, a pattern changeable position may be limited in the 2D modulation image pattern generated in the step S101. That is, the upper limit of the number of changing the patterns is determined in the reference block unit related to the error correction process, depending on the ability of the error correction process, so that the number of changes is highly possibly in the range of the error correction ability in another reference block unit even after the pattern is changed. Therefore, in view of the reference block unit related to the error correction process, priority may be given to the pattern changeable position.

As a result of the judgment in the step S106, if it is judged that the number of changes is not in the range of the error correction ability (the step S106: No), the patterns are not changed because more pattern change may influence a preferable reproduction operation. After that, the patterns cannot be changed until the reference block unit related to the error correction process is changed (i.e. until a next reference block unit appears). Therefore, next, the reference block unit is changed such that the search area is set in the next reference block unit (step S110). After that, the operational flow returns to the step S102, and the aforementioned operations are repeated.

On the other hand, as a result of the judgment in the step S106, if it is judged that the number of changes is in the range of the error correction ability (the step S106: Yes), the pattern in the search area is changed (step S107).

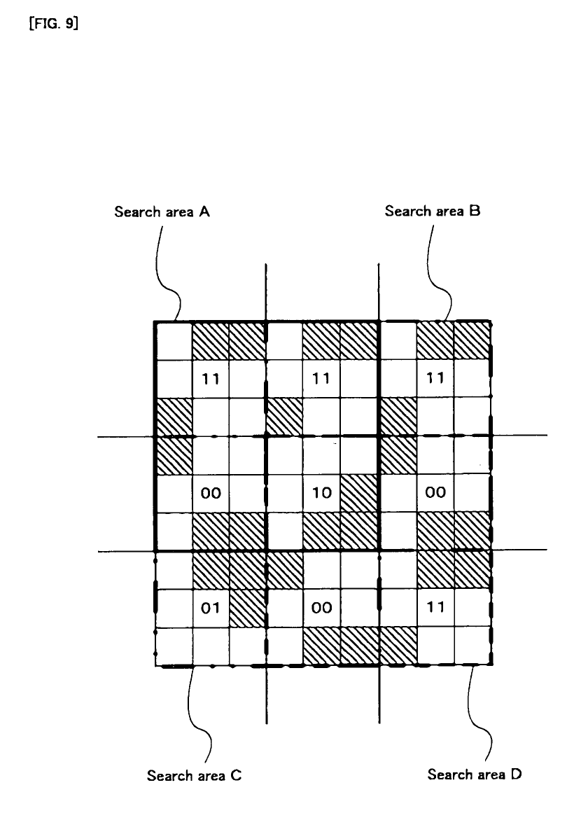

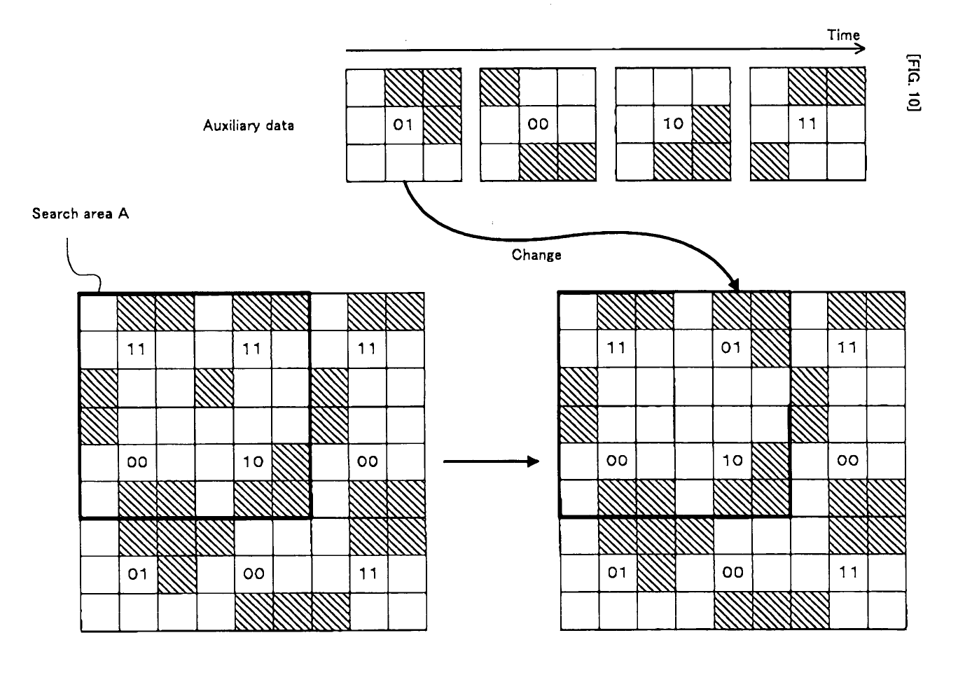

Now, with reference to FIG. 9 and FIG. 10, an explanation will be explained on a pattern change operation with respect to the 2D modulation image pattern, which is obtained by 2D-digital-modulating the actual user data or the like. FIG. 9 is a schematic diagram conceptually showing an aspect of an operation of judging whether or not the pattern is to be changed, with respect to the 2D modulation image pattern, which is obtained by 2D-digital-modulating the actual user data or the like. FIG. 10 is a schematic diagram conceptually showing an aspect of the pattern change operation, with respect to the 2D modulation image pattern, which is obtained by 2D-digital-modulating the actual user data or the like. Incidentally, the 2D modulation image pattern shown in each of FIG. 9 and FIG. 10 is the same as the 2D modulation image pattern shown in FIG. 4 i.e. the 2D modulation image pattern which is obtained by 2D-digital modulating the user data or the like which is expressed by “ . . . 111111001000010011 . . . ”).

As shown in FIG. 9, for example, with regard to a search area A (i.e. the search area that is shown in a solid line) in which the 2D modulation image pattern obtained by 2D-digital-modulating the user data or the like “11” is arranged in the upper left of the search area, the 2D modulation image pattern obtained by 2D-digital-modulating the user data or the like “11” is arranged in the upper right of the search area, the 2D modulation image pattern obtained by 2D-digital-modulating the user data or the like “00” is arranged in the lower left of the search area, and the 2D modulation image pattern obtained by 2D-digital-modulating the user data or the like “10” is arranged in the lower right of the search area, it is judged to be changed on the basis of the judgment table.

On the other hand, for example, with regard to a search area B i.e. the search area that is shown in an alternate long and short dash line) in which the 2D modulation image pattern obtained by 2D-digital-modulating the user data or the like “11” is arranged in the upper left of the search area, the 2D modulation image pattern obtained by 2D-digital-modulating the user data or the like “11” is arranged in the upper right of the search area, the 2D modulation image pattern obtained by 2D-digital-modulating the user data or the like “10” is arranged in the lower left of the search area, and the 2D modulation image pattern obtained by 2D-digital-modulating the user data or the like “00” is arranged in the lower right of the search area, it is judged to be held on the basis of the judgment table.

Moreover, for example, with regard to a search area C (i.e. the search area that is shown in a two-cot chain line) in which the 2D modulation image pattern obtained by 2D-digital-modulating the user data or the like “00” is arranged in the upper left of the search area, the 2D modulation image pattern obtained by 2D-digital-modulating the user data or the like “10” is arranged in the upper right of the search area, the 2D modulation image pattern obtained by 2D-digital-modulating the user data or the like “01” is arranged in the lower left of the search area, and the 2D modulation image pattern obtained by 2D-digital-modulating the user data or the like “00” is arranged in the lower right of the search area, it is judged to be held on the basis of the judgment table.

Moreover, for example, with regard to a search area D (i.e. the search area that is shown in a dotted line) in which the 2D modulation image pattern obtained by 2D-digital-modulating the user data or the like “10” is arranged in the upper left of the search area, the 2D modulation image pattern obtained by 2D-digital-modulating the user data or the like “00” is arranged in the upper right of the search area, the 2D modulation image pattern obtained by 2D-digital-modulating the user data or the like “00” is arranged in the lower left of the search area, and the 2D modulation image pattern obtained by 2D-digital-modulating the user data or the like “11” is arranged in the lower right of the search area, it is judged to be held on the basis of the judgment table.

Therefore, in such 2D modulation image pattern, the pattern in the search area A (in particular, one portion thereof) is changed. Specifically, as shown in FIG. 10, the pattern in the upper right portion of the search area A is changed to a 2D modulation image pattern which is generated by 2D-digital-modulating the auxiliary data expressed by “01”. More specifically, at least one pattern in the upper left portion, upper right portion, lower left portion, and lower right portion of the search area A is changed to the 2D modulation image pattern of the auxiliary data which is inputted in accordance with time series of the recording operation such that the search area A after the change does not have the portion at which one black pixels is surrounded by a plurality of white pixels.

In FIG. 6 again, following the pattern change operation, it is judged whether or not the pattern is changed by using all the auxiliary data (step S108). More specifically, it is judged whether or not all the 2D modulation pattern, which is generated by 2D-digital-modulating the auxiliary data and which is inputted to the modulation pattern change circuit 131 at a current time in the time series of the recording operation, is used to change the pattern in the search area.

As a result of the judgment in the step S108, if it is judged that the pattern is not changed by using all the auxiliary data (the step S108: No), the pattern can be still changed by using the auxiliary data, so that the operational flow returns to the step S102, a new search area is set, and the aforementioned operations are repeated.

On the other hand, if it is judged that the pattern is changed by using all the auxiliary data (the step S108: Yes), the pattern cannot be changed any more by using the auxiliary data, so that the operation is ended.

Now, with reference to FIG. 11, an explanation is given on the specific structure of the modulation pattern change circuit 131 which actually judges whether or not the aforementioned pattern change is necessary and which actually changes the pattern. FIG. 11 is a block diagram conceptually showing the specific structure of the modulation pattern change circuit 131.

As shown in FIG. 11, the modulation pattern change circuit 131 is provided with: a pattern change circuit 132; and a pattern change judgment circuit 133. The 2D modulation image pattern, which is generated by 2D-digital-modulating each of the user data and the auxiliary data, is inputted to each of the pattern change circuit 132 and the pattern change judgment circuit 133.

On the pattern change judgment circuit 133, it is judged whether or not the pattern is changed, as described above. That is, with reference to the judgment table, it is judged whether or not there is a portion at which the pattern is to be changed in the 2D modulation image pattern generated by 2D-digital-modulating the user data. After that, pattern change judgment information which indicates whether or not the pattern is to be changed is outputted from the pattern change judgment circuit 133 to the pattern change circuit 132.

The pattern change circuit 132 refers to the pattern change judgment information, which is outputted from the pattern change judgment circuit 133, to thereby actually change or hold the pattern. If the pattern is changed, the pattern change circuit 132 outputs the pattern change information which indicates the fact to the pattern change judgment circuit 133. The pattern change judgment circuit 133 judges whether or not there is further a portion at which the pattern is to be changed in the 2D modulation image patterns after the pattern is changed, with reference to the judgment table.

As explained above, according to the hologram recording/reproducing apparatus in the embodiment, the user data can be recorded into the holographic recording medium 1, while eliminating the pattern at which one black pixel is surrounded by a plurality of white pixels from the 2D modulation image patterns for example. Therefore, it is possible to preferably avoid such a disadvantage that the black pixel and the white pixel are incorrectly detected in the 2D modulation image pattern in the reproduction. In other words, it is possible to preferably avoid the incorrect detection of the 2D modulation image pattern, to thereby improve the reproduction quality.

Moreover, the pattern is changed in the range that does not exceed the error correction ability of the user data. Thus, in the reproduction, the portion at which the pattern is changed is corrected by performing the error correction process, by which the original user data i.e. the user data which is originally intended to be recorded in the recording) can be obtained preferably. That is, even if the pattern is changed, as long as the change does not exceed the error correction ability, then the pattern change does not adversely influence the reproduction. Thus, the preferable reproduction operation can be realized.

Incidentally, in the aforementioned operation, even if it is judged that the pattern in the search area cannot be changed, it may be changed by using e.g. the 2D modulation image pattern which is generated by 2D-digital modulating the auxiliary data and which is inputted to the modulation pattern change circuit 131 in the future or in the past in the time series of the recording operation.

Alternatively, instead of the auxiliary data, an arbitrary 2D digital modulation pattern may be used to change the pattern in the search area. By this, it is possible to reduce or eliminate such a possible situation that the pattern in the search area cannot be changed.

Moreover, if the pattern in the search area is changed by using the 2D modulation image pattern which is generated by 2D-digital modulating the auxiliary data, it is possible to receive the same effects as those of recording both of the user data and the auxiliary data, as will be detailed later in the explanation on the reproduction operation.

### (4) Reproduction Operation

Next, with reference to FIG. 12, an explanation will be given on the reproduction operation of a hologram reproducing apparatus in this embodiment. FIG. 12 is a schematic diagram conceptually showing a data flow in the reproduction operation of the hologram reproducing apparatus in the embodiment.

As shown in a lower left portion of FIG. 12, if user data “ . . . , 11, 11, 11, 00, 10, 00, 01, 00, 11, . . . ” is recorded, the portion at which one black pixel is surrounded by a plurality of white pixels appears in the 2D modulation image pattern. Therefore, in this case, by the aforementioned recording operation, as shown in a lower right portion of FIG. 12, one portion of the 2D modulation image pattern, which is generated by 2D-digital-modulating the user data “ . . . 11, 11, 11, 00, 10, 00, 01, 00, 11, . . . ”, is changed to the 2D modulation image patterns, each of which is generated by 2D-digital-modulating respective one of the auxiliary data expressed by “00” and the auxiliary data expressed by “01. Then, the 2D modulation image pattern at which the pattern is changed is displayed on the spatial modulator 14, to thereby record the user data or the like as the interference pattern into the holographic recording medium.

If the user data or the like recorded in the aspect is reproduced, the 2D modulation image pattern, which is shown in the lower right portion of FIG. 12, is detected by the 2D sensor 18. If the 2D modulation image pattern is demodulated by the operation of the 2D demodulation circuit 231, demodulation data “ . . . , 11, 00, 11, 01, 10, 00, 01, 00, 11, . . . ” is generated.

If the error correction process is performed on the demodulation data by the operation of the error correction circuit 241, the user data “ . . . , 11, 11, 11, 00, 10, 00, 01, 00, 11, . . . ”, which is originally intended to be recorded, is generated. By this, even if the pattern change process is performed in the recording, the original user data can be preferably obtained. As a result, the user data can be preferably reproduced.

On the other hand, the user data after the error correction process and the demodulation data before the error correction process have a different partial data portion. The different data portion indicates a portion at which the pattern is changed in the recording. That is, the data portion of the demodulation data, which is different from the user data, corresponds to the auxiliary data. Therefore, the auxiliary data extraction circuit 242 compares the demodulation data, which is outputted from the 2D demodulation circuit 231, with the user data, which is outputted from the error correction circuit 241, and extracts the different data portion as the auxiliary data. In the example shown in FIG. 12, “00, 01” is extracted as the auxiliary data.

As described above, according to the hologram recording/reproducing apparatus in the embodiment, the user data and the auxiliary data can be preferably obtained and reproduced. In particular, as described above, for example, since the pattern at which one black pixel is surrounded by a plurality of white pixels is eliminated, it is possible to preferably avoid such a disadvantage that the black pixel and the white pixel are incorrectly detected in the 2D modulation image pattern. Therefore, it is possible to preferably avoid the incorrect detection of the 2D modulation image pattern, to thereby improve the reproduction quality.

Moreover, in the embodiment, the partial pattern portion of the 2D modulation image pattern, which is generated by 2D-digital-modulating the user data, is changed to the 2D modulation image pattern which is generated by 2D-digital-modulating the auxiliary data. Thus, it is possible to realize that both the user data and the auxiliary data are recorded, so that they are overlapped per one unit of the 2D modulation image pattern i.e. the pixel unit in a matrix of 3×3).

### (5) Modified Example

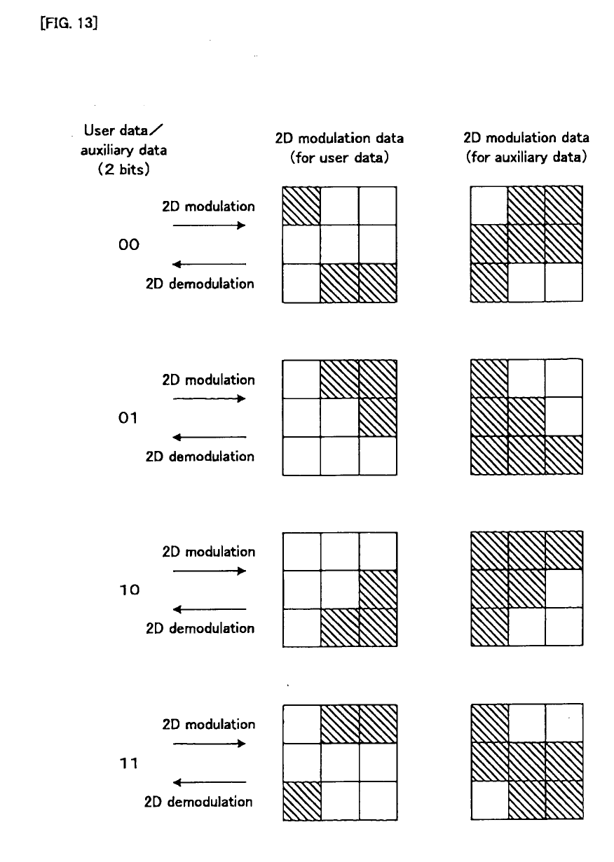

Next, with reference to FIG. 13, a modified example of the hologram recording/reproducing apparatus in the embodiment will be explained. FIG. 13 is a schematic diagram conceptually showing an aspect of modulating the user data and the auxiliary data on the hologram recording/reproducing apparatus in the modified example.

As shown in FIG. 13, on the hologram recording/reproducing apparatus in the modified example, a modulation rule for the user data is different from a modulation rule for the auxiliary data. For example, each of the modulation rule for the user data and the modulation rule for the auxiliary data is determined such that the 2D modulation image pattern which is generated by 2D-digital-modulating the user data expressed by “00” is different from the 2D modulation image pattern which is generated by 2D-digital-modulating the auxiliary data expressed by “00”. The same is true for each of the user data and the auxiliary data, expressed by “01”, “10”, and “11”.

As described above, if the modulation rule for the user data is different from the modulation rule for the auxiliary data, it is possible to relatively easily specify the portion at which the pattern is changed out of the 2D modulation image pattern, in the reproduction.

Moreover, it is also possible to include some information in the portion itself in which the pattern is changed. For example, out of the 2D modulation image patterns in a matrix of N×M, if the pattern located in the third portion from the top and in the fifth portion from the left is changed, for example, information which indicates 3×5=15 can be included.

The present invention is not limited to the aforementioned embodiment, and various changes may be made without departing from the essence or spirit of the invention which can be read from the claims and the entire specification. A hologram recording apparatus and method, a hologram reproducing apparatus and method, and a computer program, which involve such changes, are also intended to be within the technical scope of the present invention.

### INDUSTRIAL APPLICABILITY

The hologram recording apparatus and method, the hologram reproducing apparatus and method, and the computer program according to the present invention can be applied to a hologram recording apparatus for recording information into a holographic recording medium, and also applied to a hologram reproducing apparatus for reproducing the information from the holographic recording medium. Moreover, they can be applied to the hologram recording apparatus, the hologram reproducing apparatus, or the like which is mounted on various computer equipment for consumer use or for commercial use, or which can be connected to various computer equipment.

1. A hologram recording apparatus comprising:
a modulating device for modulating information data in accordance with a modulation rule related to hologram recording/reproduction, to thereby generate a modulation pattern;
a judging device for judging whether or not the modulation pattern includes a pattern portion which matches a predetermined target pattern;
a changing device for changing at least one portion of the pattern portion to a change pattern for change if it is judged by said judging device that the modulation pattern includes the pattern portion which matches the target pattern; and
an irradiating device for irradiating beams for recording the modulation pattern, in which at least one portion of the pattern portion is changed to the change pattern, into a holographic recording medium.

2. The hologram recording apparatus according to claim 1, wherein the change pattern is generated by modulating auxiliary data for controlling at least one of recording and reproduction of the information data, in accordance with the modulation rule.

3. The hologram recording apparatus according to claim 2, wherein the modulation rule for the auxiliary data is different from the modulation rule for the information data.

4. The hologram recording apparatus according to claim 1, wherein said modulating device modulates the information data while appending an error correction code to the information data.

5. The hologram recording apparatus according to claim 1, wherein said modulating device modulates the auxiliary data while appending an error correction code to the auxiliary data.

6. The hologram recording apparatus according to claim 4, wherein said changing device changes the at least one portion of the pattern portion to the change pattern, while satisfying an error correction ability of the error correction code which is appended to the information data.

7. The hologram recording apparatus according to claim 1, wherein said changing device comprises a number-of-times controlling device for controlling the number of times of the changing to the change pattern in the modulation pattern.

8. The hologram recording apparatus according to claim 1, wherein said changing device comprises a position controlling device for controlling a position in which the changing to the change pattern is performed in the modulation pattern.

9. The hologram recording apparatus according to claim 1, wherein said changing device comprises a position selecting device for preferentially selecting a position in which the changing to the change pattern is performed in the modulation pattern.

10. The hologram recording apparatus according to claim 1, wherein said judging device judges on the basis of judgment information which defines whether or not the modulation pattern, which is arbitrary and which is generated in accordance with the modulation rule, is changed to the change pattern.

11. The hologram recording apparatus according to claim 1, wherein
said modulating device generates the modulation pattern by combining unit patterns, each of which is generated by modulating one unit of the information data, in a matrix of N×M (wherein each of N and M is an integer of 1 or more), and
said changing device changes the unit pattern, as at least one portion of the pattern portion, to the change pattern.

12. The hologram recording apparatus according to claim 11, wherein said judging device judges whether or not the modulation pattern includes the pattern portion which matches the target pattern having a size of a matrix of n×m (wherein n<N and m<D).

13. A hologram recording method comprising:
a modulating process of modulating information data in accordance with a modulation rule related to hologram recording/reproduction, to thereby generate a modulation pattern;
a judging process of judging whether or not the modulation pattern includes a pattern portion which matches a predetermined target pattern;
a changing process of changing at least one portion of the pattern portion to a change pattern for change if it is judged by said judging device that the modulation pattern includes the pattern portion which matches the target pattern; and
an irradiating process of irradiating beams for recording the modulation pattern, in which at least one portion of the pattern portion is changed to the change pattern, into a holographic recording medium.

14. A hologram reproducing apparatus for reproducing information data which is recorded on a holographic recording medium by a hologram recording apparatus comprising: a modulating device for modulating the information data in accordance with a modulation rule related to hologram recording/reproduction, to thereby generate a modulation pattern; a judging device for judging whether or not the modulation pattern includes a pattern portion which matches a predetermined target pattern; a changing device for changing at least one portion of the pattern portion to a change pattern, which is generated by modulating auxiliary data for controlling at least one of recording and reproduction of the information data, in accordance with the modulation rule, if it is judged by said judging device that the modulation pattern includes the pattern portion which matches the target pattern; and an irradiating device for irradiating beams for recording the modulation pattern, in which at least one portion of the pattern portion is changed to the change pattern, into the holographic recording medium, said hologram reproducing apparatus comprising:
a reading device for reading the modulation pattern recorded on the holographic recording medium;
a demodulating device for demodulating the read modulation pattern in accordance with the modulation rule to thereby generate demodulation data;
an obtaining device for performing an error correction process on the demodulation data to thereby obtain the information data; and
an extracting device for extracting a data portion of the demodulation data which is different from the information data, as the auxiliary data.

15. A hologram reproducing method of reproducing information data which is recorded on a holographic recording medium by a hologram recording apparatus comprising: a modulating device for modulating the information data in accordance with a modulation rule related to hologram recording/reproduction, to thereby generate a modulation pattern; a judging device for judging whether or not the modulation pattern includes a pattern portion which matches a predetermined target pattern; a changing device for changing at least one portion of the pattern portion to a change pattern, which is generated by modulating auxiliary data for controlling at least one of recording and reproduction of the information data, in accordance with the modulation rule, if it is judged by said judging device that the modulation pattern includes the pattern portion which matches the target pattern; and an irradiating device for irradiating beams for recording the modulation pattern, in which at least one portion of the pattern portion is changed to the change pattern, into the holographic recording medium, said hologram reproducing method comprising:
a reading process of reading the modulation pattern recorded on the holographic recording medium;
a demodulating process of demodulating the read modulation pattern in accordance with the modulation rule to thereby generate demodulation data;
an obtaining process of performing an error correction process on the demodulation data to thereby obtain the information data; and
an extracting process of extracting a data portion of the demodulation data which is different from the information data, as the auxiliary data.

16. A computer program for hologram recording control to control a computer provided in the hologram recording apparatus according to claim 1, the computer program making the computer function as at least one portion of said modulating device, said judging device, said changing device, and said irradiating device.

17. A computer program for hologram reproduction control to control a computer provided in the hologram reproducing apparatus according to claim 14, the computer program making the computer function as at least one portion of said reading device, said demodulating device, said obtaining device, and said extracting device.
